(19) United States
(12) Patent Application Publication
(10) Pub. No.: US 2024/0142174 A1
(43) Pub. Date: May 2, 2024

(54) STORAGE RACK AND DRYING DEVICE

(71) Applicant: SUZHOU REVEDA MEDICAL BIOTECH CO., LTD., Suzhou, Jiangsu (CN)

(72) Inventors: Binwen CHEN, Suzhou, Jiangsu (CN); Ping YAN, Suzhou, Jiangsu (CN); Qiuyu QU, Suzhou, Jiangsu (CN); Long LIU, Suzhou, Jiangsu (CN); Yuan HUANG, Suzhou, Jiangsu (CN)

(21) Appl. No.: 18/558,513

(22) PCT Filed: Jul. 29, 2021
(86) PCT No.: PCT/CN2021/109123

§ 371 Date: Nov. 1, 2023

(30) Foreign Application Priority Data
Jun. 15, 2021 (CN) 202110661357.4

(51) Int. Cl. F26B 25/18; A47B 47/00

(52) U.S. Cl. CPC F26B 25/18; A47B 47/00

(57) ABSTRACT

A storage rack and a drying device including the storage rack. The storage rack includes a frame and a support beam assembly including a connector seat, a first connector and a support beam. The connector seat is connected to the frame, and the support beam is connected to the connector seat by the first connector. The support beam is connected to the frame by the first connector and the connector seat rather than by direct welding which may cause deformation. It is ensured that the support beam can provide desirable levelness for a shelf panel to be supported thereon. In this way, good levelness of the shelf panel can be achieved at a reduced thickness thereof, resulting in a reduction in economic cost. Moreover, for a detachable shelf panel, its placement and removal can be facilitated.

### TECHNICAL FIELD

The present invention relates to the field of drying equipment and, in particular, to a storage rack and a drying device.

### BACKGROUND

In industries such as biopharmaceuticals and cosmetics, numerous processes require the use of drying equipment. Existing storage racks for use in such equipment are typically composed of upright posts, support beams and shelf panels. The beams are welded to the posts, and the panels are placed on the beams. The beams, when being welded to the posts, may experience considerable thermal deformation and thus may not be able to provide sufficient levelness. Consequently, when placed on the beams, the panels may contact the beams eventually only at a few points, for example, at ends of the beams (one panel is often supported on two beams, and therefore, it contacts the beams at most at their four ends). This may lead to poor deformation resistance of the panels. Conventionally, this problem is often addressed by thickening the panels to increase their overall rigidity to enable them to provide the required levelness. Conventional shelf panels may be made as thick as 5 mm to 10 mm, leading to a weight of at least 38 Kg/m² or more per unit area. This not only means higher economic cost, but also makes the panels themselves inconvenient to remove. In addition, conventionally, after a panel is placed on beams, shims may be inserted to achieve desired levelness. This is, however, cumbersome and tedious.

### SUMMARY OF THE INVENTION

It is an object of the present invention to provide a storage rack and a drying device. Support beams in the storage rack can provide desirable levelness, allowing the use of relatively thin shelf panels and thereby resulting in a reduction in economic cost.

To this end, the present invention provides a storage rack, comprising:
a frame; and
a support beam assembly comprising a connector seat, a first connector and a support beam, the connector seat connected to the frame, the support beam connected to the connector seat through the first connector.

Optionally, the frame defines a locating recess to which the connector seat is connected.

Optionally, the support beam is configured to be vertically movable relative to the connector seat.

Optionally, the connector seat comprises a first connecting plate and a second connecting plate, which are joined to each other, the first connecting plate connected to the locating recess, the first connecting plate defining a first mounting slot which is elongate and extends vertically, the second connecting plate defining a first screw hole with an axis extending vertically, wherein the first connector is inserted through the first mounting slot and connects the first connecting plate to the support beam; and the support beam assembly further comprises an adjustment screw in threaded engagement with the first screw hole, an upper end of the adjustment screw abuts against a lower surface of the support beam.

Optionally, the connector seat comprises a first connecting plate and a second connecting plate, which are connected to each other, the first connecting plate connected to the locating recess, the second connecting plate defining a first screw hole with an axis extending vertically, wherein the support beam defines in a lower surface thereof a second mounting slot; the first connector comprises a first section and a second section, which are connected to each other axially, the first section having an external thread, the second section having a smooth outer surface; and the first connector is inserted through the first screw hole, the first section is in threaded engagement with the first screw hole, and the second section is rotatably connected to the second mounting slot of the support beam.

Optionally, the connector seat further comprises a third connecting plate connected to the second connecting plate, wherein the second connecting plate defines a second screw hole with an axis extending horizontally and perpendicularly to the first connecting plate; and the support beam assembly further comprises a pressure screw inserted through the second screw hole and pressed to abut against the support beam.

Optionally, the storage rack further comprises a shelf panel and a fixing mechanism, the shelf panel placed on the support beam, the fixing mechanism connected to the support beam and pressed to abut against an upper surface of the shelf panel.

Optionally, the fixing mechanism comprises a base, a pressing plate and a pressing mechanism, wherein the base is connected to the support beam, the pressing plate movably connected to the base, the pressing mechanism is configured to press the pressing plate so that the pressing plate abuts against the upper surface of the shelf panel.

Optionally, the pressing plate defines a second mounting slot, wherein the pressing mechanism comprises a second coupling member, a second limiting member and a resilient member, the second coupling member having an upper end connected to the second limiting member and a lower end passing through the second mounting slot in the pressing plate to connect to the base, the resilient member disposed between the second limiting member and the pressing plate in a compressed configuration.

Optionally, the fixing mechanism comprises a base, a pressing plate and an eccentric shaft, the base connected to the support beam, the pressing plate rotatably connected to the base and having an axis of rotation extending horizontally, the pressing plate defining a third mounting slot with an axis parallel to the axis of rotation of the pressing plate, the eccentric shaft connected to the third mounting slot of the pressing plate and configured to be rotatable about an axis of the third mounting slot, wherein when the eccentric shaft rotates about the axis of the third mounting slot, the pressing plate rotates in response so as to be pressed to abut against the shelf panel or move away from the shelf panel.

Optionally, the storage rack further comprises a shelf panel, and wherein the support beam assembly comprises two support beams, which are parallel, and arranged in symmetry with respect, to each other and configured to support one said shelf panel, wherein
the support beam assembly further comprises a reinforcement beam which is perpendicular, and connected at opposite ends thereof, to the two support beams.

Optionally, each of the support beams defines a first mounting notch extending vertically, wherein the reinforcement beam comprises a beam body and projections at respective opposite ends of the beam body, the projections configured for insertion into the first mounting notches.

Optionally, the support beam assembly further comprises a second connector provided with a second mounting notch and an engagement member, and wherein the second connector is mounted to one of the support beams by means of the second mounting notch, and the engagement member is configured to secure the reinforcement beam.

Optionally, the frame comprises a base plate and four upright posts which are all connected to the base plate and arranged into a rectangular pattern, wherein the support beam assembly is connected to the upright posts.

Optionally, the frame further comprises a plurality of crosspieces each connected at opposite ends thereof to respective two of the upright posts so as to be parallel or perpendicular to the support beams.

Optionally, the storage rack further comprises a plurality of adjustment legs and two levels, the adjustment legs connected to a lower surface of the base plate and configured to apply levelness adjustments to the frame, the two levels disposed perpendicularly to each other on the base plate.

Optionally, the storage rack comprises a plurality of said support beam assemblies arranged vertically on the frame at intervals.

Optionally, the shelf panel defines a plurality of weight reduction holes therein.

Compared with the prior art, the storage rack and the drying device provided in the present invention have the advantages as follows:

Firstly, the storage rack includes a frame and a support beam assembly. The support beam assembly includes connector seats, first connectors and support beams. The connector seats are attached to the frame, and the support beams are fastened to the connector seats by the first connectors. The support beams are used to support a shelf panel. According to the present invention, the support beams are mechanically connected to the frame through the first connectors and the connector seats and thereby almost experience no deformation. Thus, they can provide good levelness, which allows any shelf panel placed thereon to come into complete contact with the support beams. That is, according to the present invention, the support beams can support a shelf panel at more points which are distributed uniformly. Therefore, for a given gravitational load, the shelf panel will be subjected to a greatly reduced bending moment and hence experience little or even no deformation. Thus, the shelf panel can maintain levelness at a reduced thickness. Compared with the prior art, the present invention enables a weight per unit area of the shelf panel to be reduced to 15 Kg/m² to 26 Kg/m². In particular, when the shelf panel is configured to be detachably placed on the support beams, its placement and removal can be facilitated due to a reduced thickness and weight.

Secondly, the support beams may be configured to be vertically movable relative to the connector seats. In particular implementations, each connector seat may include a first connecting plate and a second connecting plate, which are joined to each other. Moreover, the first connecting plate may define a first mounting slot which is elongate and extends vertically, and the second connecting plate may define a first screw hole with an axis extending vertically. In addition, one of the first connectors may be inserted through the first mounting slot and connect the first connecting plate to one of the support beams, and the support beam assembly may further include adjustment screws in threaded engagement with the first screw holes, upper ends of which abut against lower surfaces of the support beams. The support beam assembly may be configured so that when any of the adjustment screws is rotated about its own axis, it will move vertically and drive the corresponding support beam to move in the same direction. Alternatively, instead of defining the first mounting slots in the first connecting plates, each of the support beams may define a second mounting slot in its lower surface. Moreover, each of the first connectors may include a first section and a second section, which are joined to each other axially. The first section may have an external thread, while the second section may have a smooth outer surface. Additionally, the first connectors may be inserted through the first screw holes, with the first sections being in threaded engagement with the first screw holes, and with the second sections being rotatably secured in the second mounting slots of the support beams. With this arrangement, when any of the first connectors is rotated about its own axis, it can move vertically and drive the corresponding support beam to move in the same direction. That is, according to the present invention, by manipulating the adjustment screws or the first connectors, height or levelness adjustments can be made to the support beams in a simple and convenient way.

### BRIEF DESCRIPTION OF THE DRAWINGS

The accompanying drawings are provided to facilitate a better understanding of the present invention and do not unduly limit the scope thereof in any sense, in which:

FIG. 1 is a schematic showing the structure of a storage rack according to an embodiment of the present invention;

FIG. 2 is a schematic showing the structure of part of a storage rack according to an embodiment of the present invention;

FIG. 3 is a schematic showing the structure of part of a storage rack according to an embodiment of the present invention, which more clearly illustrating the connection between a support beam, a connector seat and a first connector;

FIG. 4 is a partial cross-sectional view of a storage rack according to an embodiment of the present invention;

FIG. 5 is a schematic showing the structure of a connector seat in a storage rack according to an embodiment of the present invention, which includes one second connecting plate;

FIG. 6 is a schematic showing the structure of a connector seat in a storage rack according to an embodiment of the present invention, which includes two second connecting plates;

FIG. 7 is a partial cross-sectional view of a storage rack according to an alternative embodiment of the present invention;

FIG. 8 is a schematic showing the structure of part of a storage rack according to another alternative embodiment of the present invention;

FIG. 9 is a schematic showing the structure of a fixing mechanism in a storage rack according to an embodiment of the present invention;

FIG. 10 is a schematic showing the structure of a fixing mechanism in a storage rack according to an alternative embodiment of the present invention;

FIG. 11 is a schematic showing the structure of an eccentric shaft of a fixing mechanism in a storage rack according to another alternative embodiment of the present invention;

FIG. 12 is a schematic showing the structure of a fixing mechanism in a storage rack according to an alternative embodiment of the present invention, which is pressed to abut against a shelf panel;

FIG. 13 is a schematic showing the structure of a fixing mechanism in a storage rack according to an alternative embodiment of the present invention, which no longer abuts against a shelf panel;

FIG. 14 is a schematic showing the structure of a storage rack according to an embodiment of the present invention;

FIG. 15 is a schematic showing the structure of a reinforcement beam in a storage rack according to an embodiment of the present invention; and

FIG. 16 is a schematic showing the structure of a storage rack according to an alternative embodiment of the present invention.

### LIST OF REFERENCE NUMERALS IN DRAWINGS

100—Frame; 101—Locating Recess; 110—Base Plate; 120—Upright Post; 130—Crosspiece;
200—Support Beam Assembly; 210—Connector Seat; 211—First Connecting Plate; 212—Second Connecting Plate; 213—First Mounting Slot; 214—First Screw Hole; 215—Third Connecting Plate; 220—First Connector; 221—First Coupling Member; 222—First Limiting Member; 230—Support Beam; 230a—First Support Beam; 230b—Second Support Beam; 240—Adjustment Screw; 250—Pressure Screw; 260—Reinforcement Beam; 261—Beam Body; 262—Projection; 270—Second Connector; 271—Engagement Member;
300—Shelf Panel; 310—Weight Reduction Hole;
400—Adjustment Leg;
500—Level;
600—Fixing Mechanism; 610—Base; 620—Pressing Plate; 630—Pressing Mechanism; 631—Second Coupling Member; 632—Second Limiting Member; 633 Resilient Member; 640—Eccentric Shaft; 641—First Shaft Section; 642—Second Shaft Section.

### DETAILED DESCRIPTION

Particular embodiments of the present invention will be described below by way of specific examples. Based on the disclosure and teachings provided herein, a person of ordinary skill in the art will readily realize other advantages and benefits provided by the present invention. The present invention may also be otherwise embodied or applied through different embodiments, and various modifications or changes may be made to the details disclosed herein from different points of view or for different applications, without departing from the spirit of the present invention. It should be noted that the accompanying drawings are provided herein merely to schematically illustrate the basic concept of the present invention. Accordingly, they only show components relating to the present invention but not necessarily depict all the components as well as their real shapes and dimensions in practical implementations. In practice, the configurations, counts and relative scales of the components may vary arbitrarily and their arrangements may be more complicated.

In the following, each of the embodiments is described as having one or more technical features. However, this does not mean that the present invention must be practiced necessarily with all such technical features, or separately with some or all the technical features in any of the embodiments. In other words, as long as the present invention can be put into practice, a person skilled in the art may choose some or all of the technical features in any of the embodiments or combine some or all of the technical features in different embodiments based on the teachings herein and depending on relevant design specifications or the requirements of practical applications. In this way, the present invention can be carried out more flexibly.

As used herein, the singular forms “a”, “an” and “the” include plural referents, and the plural form “a plurality of” means “two or more”, unless the context clearly dictates otherwise. As used herein, the term “or” is generally employed in the sense including “and/or”, unless the context clearly dictates otherwise. The terms “mounting”, “coupling” and “connection” should be interpreted in a broad sense. For example, a connection may be a permanent, detachable or integral connection, or a mechanical or electrical connection, or a direct or indirect connection with one or more intervening media, or an internal communication or interaction between two elements. Those of ordinary skill in the art can understand the specific meanings of the above-mentioned terms herein, depending on their context.

Objects, advantages and features of the present invention will become more apparent upon reading the following more detailed description of the present invention with reference to the accompanying drawings. Note that the figures are provided in a very simplified form not necessarily drawn to exact scale and for the only purpose of facilitating easy and clear description of the embodiments. Throughout these drawings, like numerals indicate like elements.

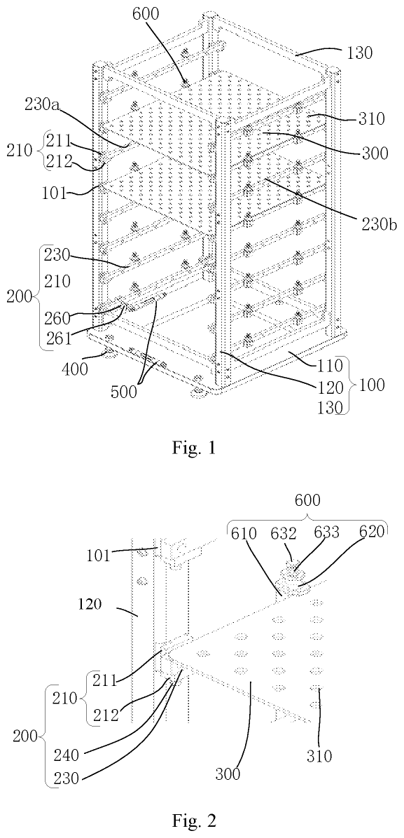

FIGS. 1, 14 and 16 is a schematic showing the structure of a storage rack according to an embodiment of the present invention. Referring to FIGS. 1, 14 and 16, the storage rack includes a frame 100, a support beam assembly 200 and a shelf panel 300. The support beam assembly 200 includes connector seats 210, first connectors 220 (as labeled in FIG. 4) and support beams 230. The connector seats 210 are attached to the frame 100, and the support beams 230 are attached to the connector seats 210 by the first connectors 220. In this way, the support beams 230 are mechanically connected to the frame 100. The shelf panel 300 is placed on the support beams 230. According to embodiments of the present invention, the support beams 230 are mechanically connected to the frame 100 by the first connectors 220 and the connector seats 210, instead of by direct welding which may cause deformation of the support beams 230. This ensures that the support beams 230 can provide levelness required to enable surface contact of the shelf panel 300 with the support beams 230 when it is placed thereon. In other words, the support beams 230 can provide uniform and sufficient support to the shelf panel 300, reducing the chance of the shelf panel 300 deforming under an excessive bending moment. Thus, desired levelness can be obtained without thickening the shelf panel 300 to increase their rigidity and hence resistance to bending moments. In other words, in the storage rack provided in this embodiment, the shelf panel 300 is allowed to have a relatively small thickness. This can result in a reduction in economic cost, and in case of the shelf panel 300 being detachably positioned on the support beams 230, the thin and thus light shelf panel 300 can be easily placed and removed.

Optionally, on the frame 100, there are a number of locating recesses 101 indicating mounting locations for the support beam assembly 200. Specifically, the frame 100 includes a base plate 110 and four upright posts 120. The base plate 110 may be rectangular, and the four upright posts 120 may be arranged at the respective corners of the base plate 110 so that lines connecting the four upright posts 120 define a rectangle. Each upright post 120 may be attached to the base plate 110 using a screw, and the locating recesses 101 may be provided on the upright posts 120.

The support beam assembly 200 may include four connector seats 210, four first connectors 220 and two support beams 230 (which are a first support beam 230a and a second support beam 230b). The first support beam 230a and the second support beam 230b are parallel, and arranged in symmetry, with respect to each other within the same plane so as to be able to together support the shelf panel 300. Specifically, opposite ends of the first support beam 230a are fastened at respective ones of the locating recesses 101 on two upright posts 110 by respective ones of the first connectors 220 and respective ones of the connector seats 210, and opposite ends of the second support beam 230b are fastened at respective ones of the locating recesses 101 on the other two upright posts 110 by respective ones of the first connectors 220 and respective ones of the connector seats 210. When the locating recesses 101 on the four upright posts 120 are located at the same height and of the same size, it will be easier for the two beams 230 to provide desirable levelness. According to embodiments of the present invention, during fabrication of the frame 100, the four upright posts 110 may be made equally long and aligned to one another, and the locating recesses 101 may be formed thereon in one pass. This allows the locating recesses 101 on the four upright posts 110 to be aligned in height and of the same size.

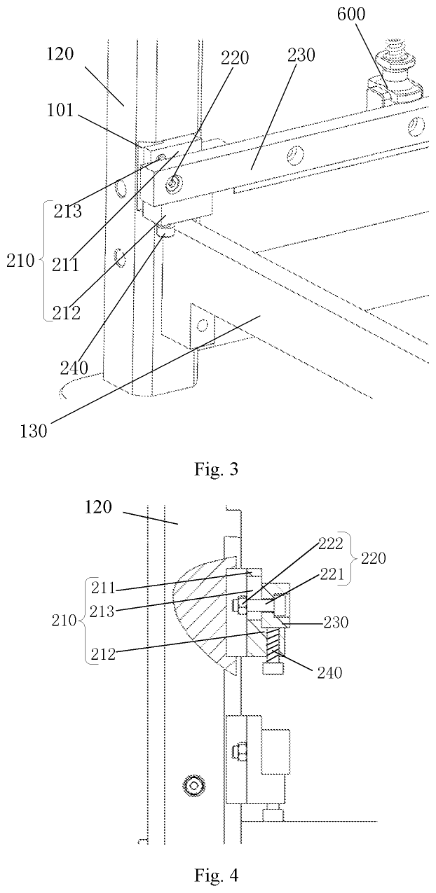

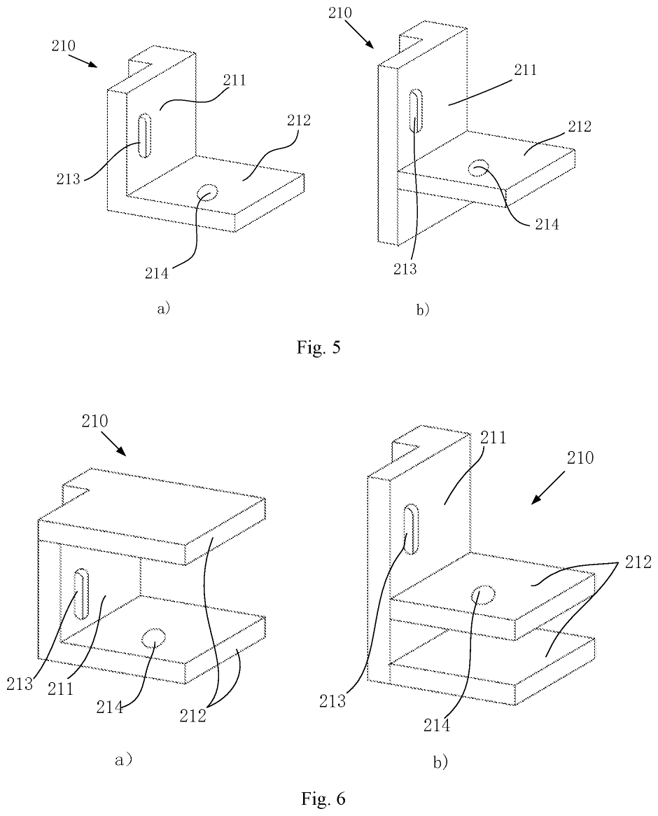

Optionally, the support beams 230 may be configured to be movable vertically relative to the connector seats 210. Referring to FIGS. 3 and 4, the connector seats 210 may each include a first connecting plate 211 and a second connecting plate 212. The first connecting plate 211 is oriented vertically and anchored in one locating recess 101. Moreover, the first connecting plate 211 may define a first mounting slot 213, which is an elongate slot extending vertically. The second connecting plate 212 may be horizontally oriented and joined to the first connecting plate 211. Moreover, the second connecting plate 212 may define a first screw hole 214 (as labeled in FIGS. 5 and 6) with an axis extending vertically. The first connectors 220 are inserted in the first mounting slots 213 and fasten the first connecting plates 211 to the support beams 230. Specifically, the first connectors 220 may each include a first coupling member 221 and a first limiting member 222. One end of the first coupling member 221 is joined to the first limiting member 222, and the other end is passed through one first mounting slot 213 and connected to one support beam 230. The first coupling member 221 may be able to move vertically within the first mounting slot 213 to drive the support beam 230 to move in the same direction. The support beam assembly 200 may further include adjustment screws 240 in threaded engagement with the first screw holes 214. Upper ends of the adjustment screws 240 are passed through the first screw holes 214 and abut against lower surfaces of the support beams 230. When any of the adjustment screws 240 is turned and thereby moves upward, it will drive the corresponding support beam 230 to move upward. When the adjustment screw 240 is turned and thereby moves downward, the support beam 230 will move downward under the action of gravity. In this way, a user can make height adjustments to the support beams 230 through adjusting four adjustment screws 240, thereby adjusting the height of the shelf panel 300 placed on the support beams 230. For example, the first coupling member 221 may be a bolt, and the first limiting member 222 may be a nut. Those skilled in the art will appreciate that fine adjustments may be made to levelness provided by the support beams 230 through adjusting some of the adjustment screws 240. The connector seats 210 may each include one first connecting plate 211 and one second connecting plate 212, which are joined together to define a L-like (detail a in FIG. 5) or T-like (detail b in FIG. 5) shape. Alternatively, the connector seats 210 may each include one first connecting plate 211 and two second connecting plates 212, which are joined together to define a F-like (detail b in FIG. 6) or [-like (detail a in FIG. 6) shape. In this case, one of the second connecting plates 212 may define a first screw hole 214, while the other may not. Further, the first connecting plate 211 and the second connecting plate(s) 212 may be integrally formed, or separately fabricated and then joined together by a screw, an adhesive or any other suitable means.

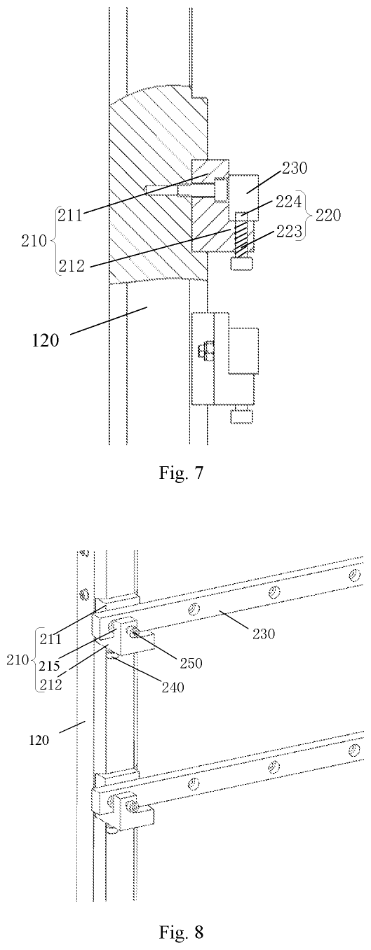

FIG. 7 shows an alternative embodiment which differs from the above embodiment in that second mounting slots (not labeled) are defined in the lower surfaces of the support beams 230 in lieu of the first mounting slots in the first connecting plates 211. The first connectors 220 may each include a first section 223 and a second section 224, which are joined together axially. The first section 223 may have an external thread, whereas the second section 224 may have a smooth exterior surface. The first connectors 220 pass through the first screw holes 214, with the first sections 223 in threaded engagement with the first screw holes 214, and with the second sections 224 rotatably received in the second mounting slots of the support beams 230.

In another alternative embodiment, the first connectors 220 are screws which fasten the support beams 230 to the connector seats 210 in such a manner that support beams 230 are not adjustable in height.

As shown in FIG. 8, the connector seats 210 may each further include a third connecting plate 215 joined to the second connecting plate 212. The third connecting plate 215 may define a second screw hole (not shown) with an axis extending horizontally and perpendicularly to the first connecting plate 211. The support beam assembly 200 may further include pressure screws 250 which are inserted through the second screw holes and pressed to abut against the support beams 230. This can stabilize the support beams 230 and avoid their wobbling.

Further, those skilled in the art will appreciate that the storage rack may include a plurality of support beam assemblies 200 secured to the frame 100 at vertical intervals, and a plurality of shelf panels 300 may be placed thereon to increase utilization of the storage rack. Accordingly, each upright post 120 may define a plurality of locating recesses 101 spaced apart at vertical intervals. Moreover, the user may change a storage space defined between two shelf panels 300 of interest by removing one or more shelf panels 300.

The storage rack may further include multiple adjustment legs 400, which are all secured to the base plate 110 in order to apply levelness adjustments to the frame 100. The adjustment legs 400 may be implemented as commercial products available on the market. The storage rack may further include two levels 500 disposed on an upper surface into perpendicularity with each other in order to provide reference for levelness in two directions.

Preferably, the frame 100 may further include multiple crosspieces 130 each attached at its opposite ends to two of the upright posts 120, either perpendicularly or parallel to the support beams 230. Preferably, eight crosspieces 130 are provided and attached to upper and lower ends of the posts 120 in order to stabilize the frame 100.

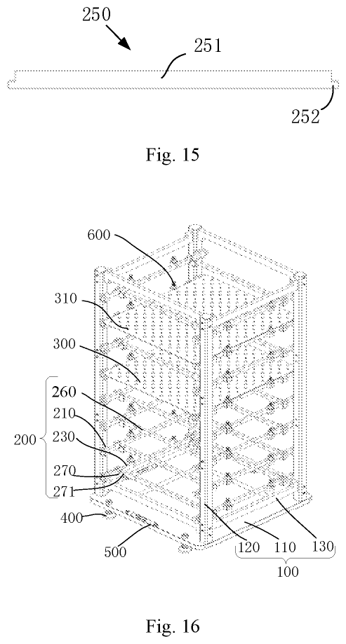

Referring to FIGS. 14 to 16, in case of a large horizontal dimension of the storage rack and hence the shelf panel 300, the support beam assembly 200 is preferred to further include a reinforcement beam 260 disposed perpendicularly to the support beams 230. Opposite ends of the reinforcement beam 260 are attached to the respective two support beams 230 in order to provide secondary support to the shelf panel 300 and prevent its deformation. Specifically, the support beam 230 may each define a vertically-extending first mounting notch (not shown) which is open at the top and closed at the bottom. As shown in FIG. 15, the reinforcement beam 260 may include a beam body 261 and projections 262 at opposite ends of the beam body 261, which are configured for insertion into the first mounting notches. Alternatively, referring again to FIG. 16, in conjunction with FIG. 1, the support beam assembly 200 may further include second connectors 270 each including a second mounting notch (not labeled) and engagement members 271. The second connectors 270 are mounted to the support beams 230 by means of the second mounting notches, and the engagement members 271 are used to secure the reinforcement beam 260.

Preferably, the shelf panel 300 is placed on both the support beams 230 (with a lower surface of the shelf panel 300 being in contact with upper surfaces of the support beams 230) and the reinforcement beam 260 (if present). The storage rack may further include fixing mechanisms 600 attached to the support beams 230. The fixing mechanisms 600 may be partially pressed to abut against an upper surface of the shelf panel 300 so that they clamp the shelf panel 300 together with the support beams 230 to immobilize the shelf panel 300.

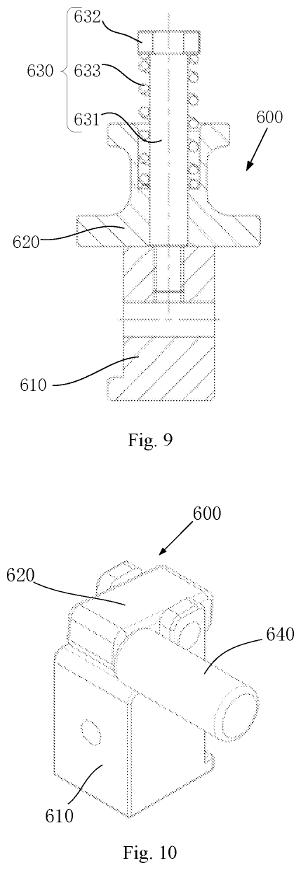

In a non-limiting embodiment, as shown in FIGS. 2 and 9, each fixing mechanism 600 may include a base 610, a pressing plate 620 and a pressing mechanism 630. The base 610 is mounted to one support beam 230, and the pressing plate 620 is movably coupled to the base 610. The pressing mechanism 630 is configured to press the pressing plate 620 to bring the pressing plate 620 to abut against the upper surface of the shelf panel 300. Specifically, the pressing plate 620 may define a second mounting slot (not shown), and the pressing mechanism 630 may include a second coupling member 631, a second limiting member 632 and a resilient member 633. The second coupling member 631 is joined at the top to the second limiting member 632, and its lower end is passed through the second mounting slot in the pressing plate 620 and attached to the base 610. The resilient member 633 may be, for example, a spring disposed over the second coupling member 631 between the pressing plate 620 and the second limiting member 632 in a compressed configuration. With this design, the pressing plate 620 is able to both move vertically along the second coupling member 631 and rotate about the second coupling member 631. When the shelf panel 300 is placed on the support beams 230 and the pressing plate 620 resides on the upper surface of the shelf panel 300, the resilient member 633 can press the pressing plate 620 against the shelf panel 300. The pressing plate 620 may be rotated away from the shelf panel 300, so that the pressing plate 620 no longer abuts against the shelf panel 300. It would be appreciated that, in order to rotate the shelf panel 300, the pressing plate 620 may be lifted so as to be not in contact with the shelf panel 300 to allow reduced friction resistance during the rotation.

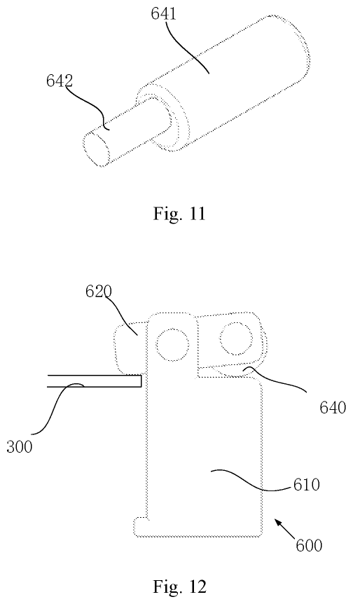

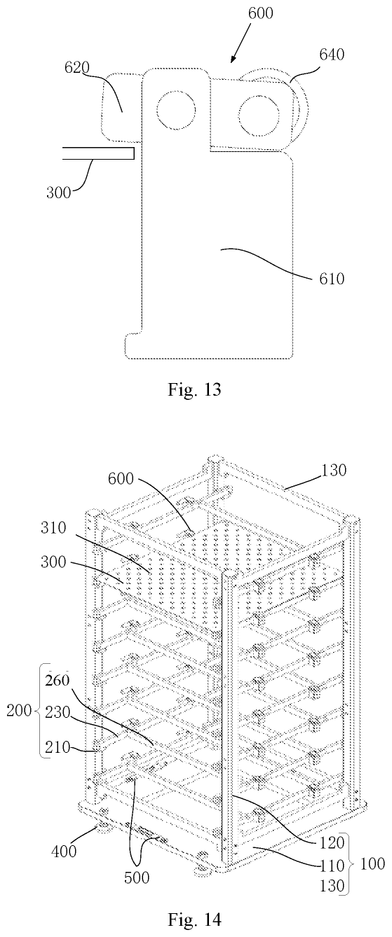

Refer to FIGS. 10 and 11, in an alternative embodiment, the pressing plate 620 is rotatably disposed on the base 610, with its axis of rotation extending horizontally. The pressing plate 620 may define a third mounting slot (not labeled), and the fixing mechanism 600 includes an eccentric shaft 640 which may include a first shaft section 641 and a second shaft section 642 eccentric with respect to the first shaft section 641. The second shaft section 642 is disposed within the third mounting slot of the pressing plate 620 so as to be rotatable about an axis of the third mounting slot. When the eccentric shaft 640 rotates about the axis of the third mounting slot, the center of the eccentric shaft 640 will also rotate and thereby drive the pressing plate 620 to rotate on the base 610. For example, the shelf panel 300 may be located on the left side of the base 610, as shown in FIGS. 12 and 13. In this case, when the eccentric shaft 640 is rotated so that its center of gravity is positioned on the left side of the third mounting slot, the pressing plate 620 will be pressed to abut against the shelf panel 300 (see FIG. 12). When the eccentric shaft 640 is rotated so that its center of gravity is positioned on the right side of the third mounting slot, the pressing plate 620 will rotate clockwise away from the shelf panel 300 (see FIG. 13).

Further, in order to allow the shelf panel 300 to have a reduced weight, multiple holes 310 may be formed therein.

Although the present invention has been disclosed hereinabove, it is not limited to the above disclosure. Those skilled in the art can make various changes and modifications to the invention without departing from the spirit and scope thereof. Accordingly, it is intended that any and all such changes and modifications also fall within the scope of the present invention as defined by the appended claims and equivalents thereof.

1. A storage rack, comprising:
a frame; and
a support beam assembly comprising a connector seat, a first connector and a support beam, the connector seat connected to the frame, the support beam connected to the connector seat through the first connector.

2. The storage rack according to claim 1, wherein the frame defines a locating recess to which the connector seat is connected.

3. The storage rack according to claim 2, wherein the support beam is configured to be vertically movable relative to the connector seat.

4. The storage rack according to claim 3, wherein the connector seat comprises a first connecting plate and a second connecting plate, which are joined to each other, the first connecting plate connected to the locating recess, the first connecting plate defining a first mounting slot which is elongate and extends vertically, the second connecting plate defining a first screw hole with an axis extending vertically, wherein the first connector is inserted through the first mounting slot and connects the first connecting plate to the support beam; and the support beam assembly further comprises an adjustment screw in threaded engagement with the first screw hole, an upper end of the adjustment screw abuts against a lower surface of the support beam.

5. The storage rack according to claim 3, wherein the connector seat comprises a first connecting plate and a second connecting plate, which are connected to each other, the first connecting plate connected to the locating recess, the second connecting plate defining a first screw hole with an axis extending vertically, wherein the support beam defines in a lower surface thereof a second mounting slot; the first connector comprises a first section and a second section, which are connected to each other axially, the first section having an external thread, the second section having a smooth outer surface; and the first connector is inserted through the first screw hole, the first section is in threaded engagement with the first screw hole, and the second section is rotatably connected to the second mounting slot of the support beam.

6. The storage rack according to claim 4, wherein the connector seat further comprises a third connecting plate connected to the second connecting plate, wherein the second connecting plate defines a second screw hole with an axis extending horizontally and perpendicularly to the first connecting plate; and the support beam assembly further comprises a pressure screw inserted through the second screw hole and pressed to abut against the support beam.

7. The storage rack according to claim 1, further comprising a shelf panel and a fixing mechanism, the shelf panel placed on the support beam, the fixing mechanism connected to the support beam and pressed to abut against an upper surface of the shelf panel.

8. The storage rack according to claim 7, wherein the fixing mechanism comprises a base, a pressing plate and a pressing mechanism, wherein the base is connected to the support beam, the pressing plate movably connected to the base, the pressing mechanism is configured to press the pressing plate so that the pressing plate abuts against the upper surface of the shelf panel.

9. The storage rack according to claim 8, wherein the pressing plate defines a second mounting slot, wherein the pressing mechanism comprises a second coupling member, a second limiting member and a resilient member, the second coupling member having an upper end connected to the second limiting member and a lower end passing through the second mounting slot in the pressing plate to connect to the base, the resilient member disposed between the second limiting member and the pressing plate in a compressed configuration.

10. The storage rack according to claim 7, wherein the fixing mechanism comprises a base, a pressing plate and an eccentric shaft, the base connected to the support beam, the pressing plate rotatably connected to the base and having an axis of rotation extending horizontally, the pressing plate defining a third mounting slot with an axis parallel to the axis of rotation of the pressing plate, the eccentric shaft connected to the third mounting slot of the pressing plate and configured to be rotatable about an axis of the third mounting slot, wherein when the eccentric shaft rotates about the axis of the third mounting slot, the pressing plate rotates in response so as to be pressed to abut against the shelf panel or move away from the shelf panel.

11. The storage rack according to claim 7, further comprising a shelf panel, and wherein the support beam assembly comprises two support beams, which are parallel, and arranged in symmetry with respect, to each other and configured to support one said shelf panel, wherein
the support beam assembly further comprises a reinforcement beam which is perpendicular, and connected at opposite ends thereof, to the two support beams.

12. The storage rack according to claim 11, wherein each of the support beams defines a first mounting notch extending vertically, wherein the reinforcement beam comprises a beam body and projections at respective opposite ends of the beam body, the projections configured for insertion into the first mounting notches.

13. The storage rack according to claim 11, wherein the support beam assembly further comprises a second connector provided with a second mounting notch and an engagement member, and wherein the second connector is mounted to one of the support beams by means of the second mounting notch, and the engagement member is configured to secure the reinforcement beam.

14. The storage rack according to claim 1, wherein the frame comprises a base plate and four upright posts which are all connected to the base plate and arranged into a rectangular pattern, wherein the support beam assembly is connected to the upright posts.

15. The storage rack according to claim 14, wherein the frame further comprises a plurality of crosspieces each connected at opposite ends thereof to respective two of the upright posts so as to be parallel or perpendicular to the support beams.

16. The storage rack according to claim 14, further comprising a plurality of adjustment legs and two levels, the adjustment legs connected to a lower surface of the base plate and configured to apply levelness adjustments to the frame, the two levels disposed perpendicularly to each other on the base plate.

17. The storage rack according to claim 1, comprising a plurality of said support beam assemblies arranged vertically on the frame at intervals.

18. The storage rack according to claim 7, wherein the shelf panel defines a plurality of weight reduction holes therein.

19. A drying device, comprising a heat source and the storage rack of claim 1, the heat source configured to heat and dry an object placed on the storage rack.
